(19) United States
(12) Patent Application Publication
(10) Pub. No.: US 2022/0266341 A1
(43) Pub. Date: Aug. 25, 2022

(54) ADDITIVE MANUFACTURING SYSTEM, ADDITIVE MANUFACTURING METHOD AND COMPUTER-READABLE MEDIUM

(71) Applicant: Airbus (Beijing) Engineering Centre Company Limited, Beijing (CN)

(72) Inventors: Ming LIU, Beijing (CN); Miguel LOPEZ SAN GREGORIO, Beijing (CN)

(21) Appl. No.: 17/673,529

(22) Filed: Feb. 16, 2022

(30) Foreign Application Priority Data
Feb. 19, 2021 (CN) 202110189280.5

(51) Int. Cl. B22F 10/50; B22F 10/28; B33Y 10/00; B33Y 30/00; B33Y 40/20; B33Y 50/02; B23K 26/352

(52) U.S. Cl. CPC B22F 10/50; B22F 10/28; B33Y 10/00; B33Y 30/00; B33Y 40/20; B33Y 50/02; B23K 26/3576; B23K 37/02

(57) ABSTRACT

An additive manufacturing system is disclosed including an additive manufacturing unit, a surface treatment unit and a control unit. The additive manufacturing unit includes a material feeding device and a heat source device, the material feeding device is configured to supply a material onto a substrate for layer-by-layer additive manufacturing, and the heat source device is configured to provide a heat source for fusing the material layer by layer to form material layers. The surface treatment unit is configured to perform surface treatment on the material layers. The control unit is configured to control the additive manufacturing unit and the surface treatment unit. The surface treatment unit is configured to perform surface treatment on a material layer N after the material layer N is formed and before a material layer N+1 is formed on the material layer N, where N is an integer greater than or equal to 1.

### FIELD

The present disclosure relates to the technical field of material processing and, in particular, to an additive manufacturing system and an additive manufacturing method in which materials are melted and deposited for additive manufacturing.

### BACKGROUND

Additive layer manufacturing (ALM) technology is a technology of using a computer to design a product and then printing the product with a printer. In computer design, the product to be formed is modeled; the model is sliced into many 2D layers; and the design data of each layer is stored in the computer for printing. During the printing process, the material is continuously printed layer by layer (that is, fusion and deposition) by means of a heat source until the final 3D product is formed.

However, the formed 3D product has many interlayer defects such as porosity, cracks, inclusion, and lack of fusion. These defects will affect the quality, performance and service life of the product. At present, there is no effective or economical way to inspect and control the interlayer defects of products (especially, large-sized products).

In addition, after layer-by-layer processing, the product will have larger layer cumulative manufacturing errors which significantly decrease the processing accuracy of the product.

### SUMMARY

An object of the present disclosure is to provide an additive manufacturing system and an additive manufacturing method that can reduce interlayer defects and/or improve processing accuracy.

According to an aspect of the present disclosure, an additive manufacturing system is provided. The additive manufacturing system includes an additive manufacturing unit, a surface treatment unit and a control unit. The additive manufacturing unit includes a material feeding device and a heat source device, wherein the material feeding device is configured to supply a material to a substrate for layer-by-layer additive manufacturing, and the heat source device is configured to provide a heat source for fusing or sintering the material layer by layer to form material layers. The surface treatment unit is configured to perform surface treatment on the material layers. The control unit is configured to control the additive manufacturing unit and the surface treatment unit. The surface treatment unit is configured to perform surface treatment on a material layer N after the material layer N is formed and before a material layer N+1 is formed on the material layer N, where N is an integer greater than or equal to 1.

In the additive manufacturing system of the present disclosure, since the surface treatment device that processes the material layers is provided, interlayer defects can be reduced, thereby improving the performance of the product. In addition, the surface treatment of the material layers by the surface treatment device can eliminate layer processing errors, thereby avoiding the cumulative processing errors of the product, improving and ensuring the dimensional accuracy of the product.

The additive manufacturing system according to the present disclosure can improve the performance and quality of the product. The formed product can meet use requirements, so that post-processing thereof may be omitted, which is particularly advantageous for large-sized products.

In addition, since the surface treatment of a material layer is performed once the material layer is formed, requirements on the processing environment can be lowered. For example, there is no need to process the product in a vacuum environment or a vacuum room.

In some examples of the additive manufacturing system, the surface treatment unit is configured to, after each of the material layers is formed, perform the surface treatment on the material layer.

In some examples of the additive manufacturing system, the surface treatment unit includes a polishing device. In particular, the polishing device may be a laser polishing device.

In some examples of the additive manufacturing system, the heat source device is a laser heat source device or an arc heat source device.

The surface treatment device and/or the heat source device can be selected according to the material type and product processing parameters.

In some examples of the additive manufacturing system, the heat source device is a non-molten inert gas shielded welding machine, and/or along a forming direction of the material layer, the non-molten inert gas shielded welding machine is located behind the molten pool, while the material feeding device is located in front of or behind the molten pool.

In some examples of the additive manufacturing system, the heat source device is a melt inert gas welding machine, and/or along the forming direction of the material layer, the melt inert gas welding machine is located behind the molten pool.

In some examples of the additive manufacturing system, the heat source device and the surface treatment unit are configured to be movable relative to the substrate.

According to another aspect of the present disclosure, an additive manufacturing method is provided. The additive manufacturing method includes: supplying a material onto a substrate by a material feeding device for layer-by-layer additive manufacturing; and fusing the material layer by layer by a heat source device to form material layers. The method further includes performing surface treatment by a surface treatment unit on a material layer N after the material layer N is formed and before a material layer N+1 is formed on the material layer N, where N is an integer greater than or equal to 1.

In some examples of the additive manufacturing method, after each of the material layers in the one material layer is formed, the surface treatment unit performs surface treatment on the material layer.

In some examples of the additive manufacturing method, the surface treatment unit performs laser polishing on the material layers.

In some examples of the additive manufacturing method, the method may further include: moving the heat source device and the surface treatment unit relative to the substrate during the additive manufacturing and the surface treatment.

According to yet another aspect of the present disclosure, a computer-readable medium is provided, which stores a program executed by a processor of the control unit to implement the above additive manufacturing method.

Features and other advantages of the present disclosure will become apparent from the following non-limiting detailed description.

### BRIEF DESCRIPTION OF THE DRAWINGS

Features and advantages of one or more embodiments of the present disclosure will become easier to be understood through the following description in conjunction with the drawings, in which:

FIG. 1 is a schematic view of functional modules of an additive manufacturing system according to the present disclosure;

FIGS. 2A to 2D are schematic views showing various processing stages of the additive manufacturing system according to an embodiment of the present disclosure;

FIG. 3 is a schematic structural view of the additive manufacturing system according to another embodiment of the present disclosure;

FIG. 4 is a schematic structural view of the additive manufacturing system according to yet another embodiment of the present disclosure;

FIG. 5 is a schematic structural view of the additive manufacturing system according to further another embodiment of the present disclosure; and

FIG. 6 is a flowchart of an additive manufacturing method according to an embodiment of the present disclosure.

In all the drawings, corresponding reference numerals indicate corresponding parts.

### DETAILED DESCRIPTION OF THE EMBODIMENTS

The present disclosure will be described in detail hereinafter in conjunction with the drawings by way of the exemplary embodiments. The following detailed description of the present disclosure is merely for illustrative and is by no means intended to limit the present disclosure, its application or usage.

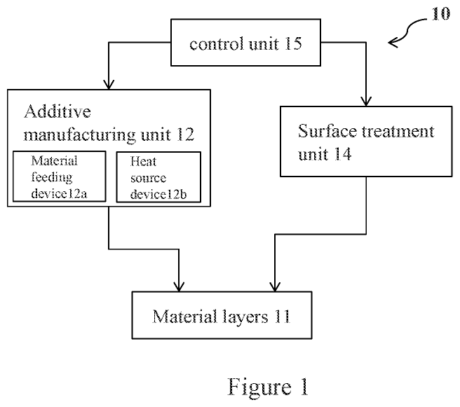

FIG. 1 is a schematic view of functional modules of an additive manufacturing system 10 according to the present disclosure. The additive manufacturing system 10 is a system that uses additive manufacturing technology (ALM) to form a product layer by layer. As shown in FIG. 1, the additive manufacturing system 10 includes an additive manufacturing unit 12 for forming material layers 11, a surface treatment unit 14 for performing surface treatment on the formed material layers 11, and a control unit 15 for controlling the additive manufacturing unit 12 and the surface treatment unit 14.

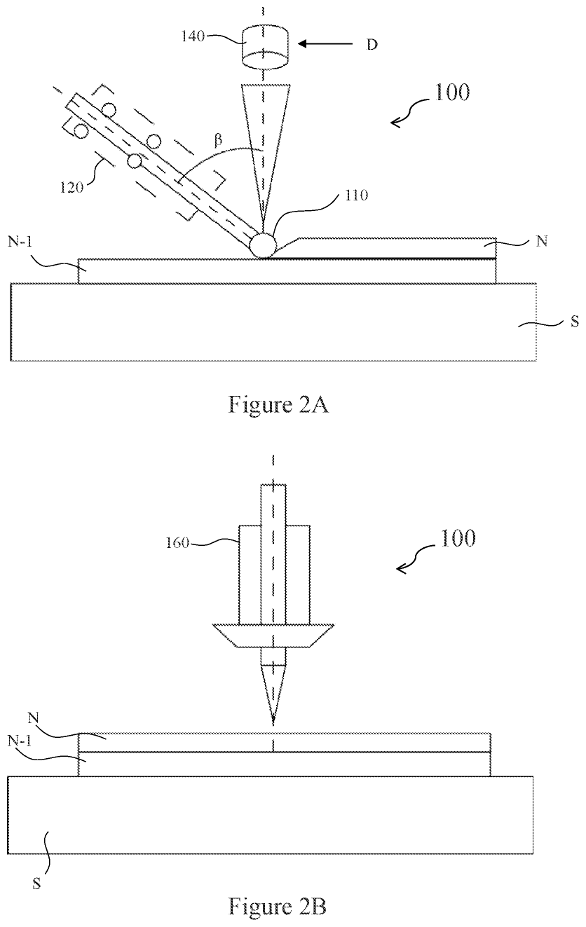

The additive manufacturing unit 12 includes a material feeding device 12a and a heat source device 12b. The material feeding device 12a is configured to supply a material onto a substrate S (shown in FIG. 2A) for layer-by-layer additive manufacturing. The heat source device 12b is configured to fuse or sinter the materials layer by layer to form the material layers 11.

The surface treatment unit 14 is configured to perform surface treatment on the material layers 11 after the material layers 11 are formed. For example, the material layers 11 are polished to remove molten ashes, burrs, cracks, oxide layers, and the like, so as to smooth the surfaces of the material layers 11 or eliminate manufacturing errors, thereby improving the quality, performance, or dimensional accuracy of the material layers. For example, the material layers 11 are processed by laser to improve the microstructures of the material layers 11 to such an extent that the material layers have a certain degree of cleanliness or required roughness, thereby improving the mechanical properties thereof or the like. For example, the material layers 11 are cleaned to remove impurities, contaminants, or the like, so as to enhance the bonding force between the material layers, thereby improving the physical and chemical properties of the formed product. The surface treatment can be varied according to requirements on the additive manufacturing process, the performance, etc. of the product.

The product formed by depositing the surface-treated material layers 11 can have the required performance and quality, so that post-processing of the product can be omitted or reduced, which is particularly advantageous for large-sized products.

Since the additive manufacturing system 10 according to the present disclosure can perform surface treatment on the material layers 11 after the material layers 11 are formed, the environmental requirements for the additive manufacturing of the product can be lowered. For example, the additive manufacturing can be performed in an unsheltered environment, that is, a vacuum room can be dispensed with.

The control unit 15 controls the operation and switching of the additive manufacturing unit 12 and the surface treatment unit 14 based on the data of modeling and slicing of the product. For example, the control unit 15 may control the additive manufacturing unit 12 (the material feeding device 12a and the heat source device 12b) and the surface treatment unit 14 to move relative to the substrate. The substrate may be stationary, thereby ensuring a high forming accuracy.

FIGS. 2A to 2D show various processing stages of an additive manufacturing system 100 according to an embodiment of the present disclosure. As shown, the additive manufacturing system 100 includes a substrate S, a wire feeder 120 as the material feeding device 12a for supplying wire material onto the substrate S, a laser heat source device 140 as the heat source device 12b for fusing materials to form a molten pool 110, and a laser polishing device 160 constituting the surface treatment unit 14 for performing surface treatment on the material layers.

It is noted that various components of the additive manufacturing system 100 are shown only schematically in the drawings. For example, the substrate S shown in the drawings is substantially plate-shaped. However, it is noted that the substrate S shown in the drawings is only schematic. The substrate S refers to a workbench or a support structure on which the product is processed, so the shape and size of the substrate S may be varied according to the structure or processing requirements of the product to be formed.

FIG. 2A shows the additive manufacturing of the material layer N of the product. As shown, the material layer N−1 has been formed on the substrate S, and the additive manufacturing unit 12 is processing and forming the material layer N. Herein, N can be understood as the number of the material layers. During the additive manufacturing, the wire feeder 120 supplies the wire material on the material layer N−1 along a direction D, and the laser heat source device 140 irradiates the laser onto the material to melt the material to form the molten pool 110. A material layer is formed as the wire material is supplied, melted and solidified.

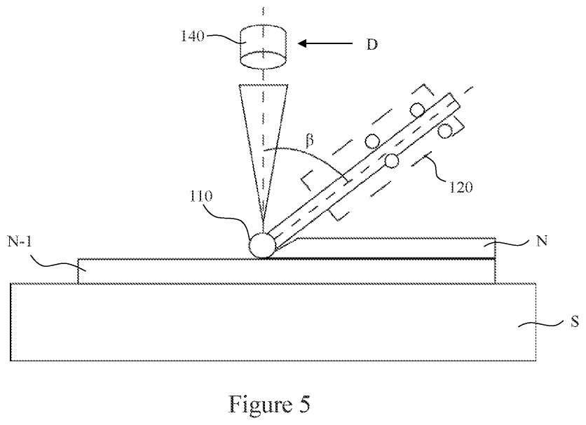

In the example shown in FIG. 2A, the laser heat source device 140 is substantially perpendicular to the substrate S, and the wire feed 120 is arranged obliquely at an angle β relative to the laser heat source device 140. That is, the center axis of the wire feeder 120 is at an angle β relative to the center axis of the laser heat source device 140. The angle β can be determined according to the material supply rate, the heat source power, etc. The wire feeder 120 is located in front of the molten pool 110 in the forming direction of the material layer N, so that the wire material can be preheated. It is noted that the laser heat source device 140 and the wire feeder 120 may be arranged in other ways as long as they can achieve the functions described herein. For example, as shown in FIG. 5, the wire feeder 120 is located behind the molten pool 110 in the forming direction of the material layer N.

FIG. 2B shows the process of performing surface treatment on the material layer N after the material layer N is formed. In FIG. 2B, the material layer N is polished by the laser polishing device 160. The polished surface is the surface on which the material layer N+1 is to be formed. By polishing the material layer N, processing defects can be decreased to improve the quality and performance of the material layer N and the bonding force of the material layer N with the material layer N+1, and to eliminate processing errors so as to ensure the dimensional accuracy of the material layer of the product.

FIG. 2C shows the additive manufacturing of the material layer N+1. As shown, the material layer N has been formed on the substrate S, and the additive manufacturing unit 12 is processing and forming the material layer N+1. Specifically, the wire feeder 120 supplies the wire material on the material layer N in the direction D, and the laser heat source device 140 irradiates the laser onto the material to melt the material to form the material layer N+1.

FIG. 2D shows the process of performing surface treatment on the material layer N+1. In FIG. 2D, the material layer N+1 is polished by the laser polishing device 160. The polished surface is the surface on which the material layer N+2 is to be formed.

The surface treatment device (e.g., the laser polishing device 160) according to the present disclosure performs surface treatment on the material layer, and thus the treatment process of the surface treatment device, and the structures and operations of the surface treatment device and the control device can be simplified.

In the existing additive manufacturing system, the product is subjected to surface treatment (such as polishing treatment) generally after being formed, so as to meet the appearance requirements or overall size requirements of the product. After being formed, the product has a complicated shape (for example, concave-convex structure, sharp corner, hole, etc.). Thus, a large-sized surface treatment apparatus is thereby required, and the structure and operation of the surface treatment apparatus become complicated, which is difficultly controlled or is difficultly ensure the surface treatment quality. In addition, performing surface treatment after the product is formed cannot eliminate the interlayer defects or the layer processing errors, which ultimately results in large cumulative processing errors.

In the embodiments of the present disclosure, the surface treatment is performed immediately after one material layer of the product is formed and before the next material layer is formed thereon, so that various defects in this material layer can be effectively removed. These various defects would not be accumulated in the final product as interlayer defects, and the manufacturing errors of the final product can be decreased.

In the example shown in FIGS. 2A to 2D, the laser heat source device 140 and the laser polishing device 160 may use the different lasers (not shown). In this way, the laser heat source device 140 and the laser polishing device 160 may be designed flexibly. It is noted that the laser heat source device and the laser polishing device may use the same laser, which may reduce the cost or make a compact structure of the additive manufacturing system.

It is noted that, according to the processing or performance requirements of different material layers of the product, different surface treatment devices may be adopted to perform surface treatment on the different material layers. Surface treatment may be performed on each material layer, or may be performed on a predetermined material layer to meet specific requirements thereof. For example, surface treatment may be performed on a material layer, which is subjected to greater stress during usage of the product, thereby ensuring a strong bearing capacity. While surface treatment may not be performed on a material layer, which is subjected to less stress during usage of the product. Thus, the quality and performance requirements of the product can be guaranteed while improving the production efficiency.

In the example shown in FIGS. 2A to 2D, the material feeding device 12a is the wire feeder 120 for supplying wire materials.

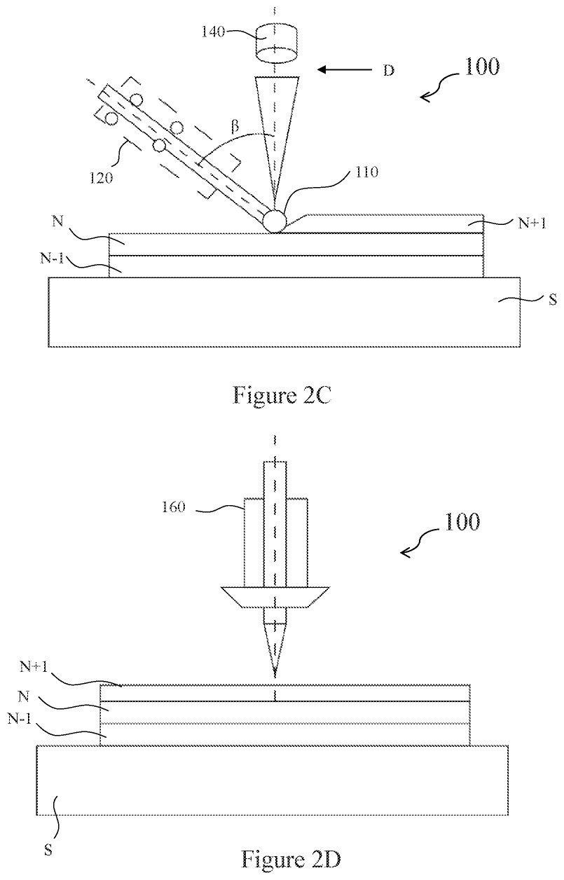

FIG. 3 shows an additive manufacturing system 200 according to another embodiment of the present disclosure. The same parts of the additive manufacturing system 200 shown in FIG. 3 as the additive manufacturing system 100 shown in FIGS. 2A to 2D are denoted by the same reference numerals, and detailed descriptions thereof are omitted. Different parts of the additive manufacturing system 200 shown in FIG. 3 from the additive manufacturing system 100 shown in FIGS. 2A to 2D will be described in detail hereinafter.

The additive manufacturing system 200 differs from the additive manufacturing system 100 in use of a melt inert gas welding machine (MIG) 240 as the heat source device. The melt inert gas welding machine 240 provides an arc heat source for melting or sintering materials.

As shown in FIG. 3, the melt inert gas welding machine 240 and the wire feeder 220 are located on a same side of the molten pool 210. In the forming direction D of the material layer N+1 (or the moving direction of the melt inert gas welding machine 240), the melt inert gas welding machine 240 (and the wire feeder 220) may be located behind the molten pool, which can reduce the cooling rate of the molten pool. The melt inert gas welding machine 240 may be integrated with the wire feeder 220. The melt inert gas welding machine 240 and the wire feeder 220 may be arranged obliquely at an angle α with respect to the vertical direction. The angle α may be varied according to the type of material, the supply rate of the material, and the like.

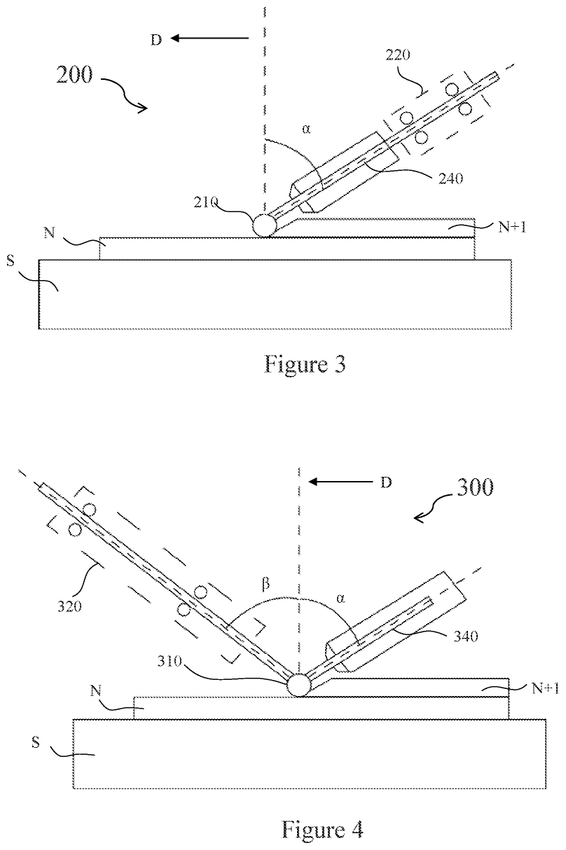

FIG. 4 shows an additive manufacturing system 300 according to yet another embodiment of the present disclosure. The additive manufacturing system 300 differs from the additive manufacturing system 200 in use of a non-molten inert gas shielded welding machine 340 as the heat source device. For example, the non-molten inert gas shielded welding machine is a tungsten inert gas welding machine (TIG). Similar to the melt inert gas welding machine 240, the non-molten inert gas shielded welding machine 340 provides an arc heat source for melting or sintering materials.

In the example shown in FIG. 4, the wire feeder 320 and the non-molten inert gas shielded welding machine 340 may be located on two opposite sides of the molten pool 310. In the forming direction D of the material layer N+1 (or the moving direction of the non-molten inert gas shielded welding machine 340), the wire feeder 320 is arranged obliquely in front of the molten pool 310 at an angle β with respect to the vertical direction, and the non-molten inert gas shielded welding machine 340 is arranged obliquely behind the molten pool 310 at an angle α with respect to the vertical direction. According to different process parameters, angle α and angle β may be changed.

It is noted that the arrangement of the wire feeder 320 and the non-molten inert gas shielded welding machine 340 is not limited to the specific example shown in FIG. 4 but may be changed according to actual needs. For example, the wire feeder 320 may be located behind the molten pool 310 in the forming direction D of the material layer.

A suitable heat source device may be selected according to the selected materials or process parameters.

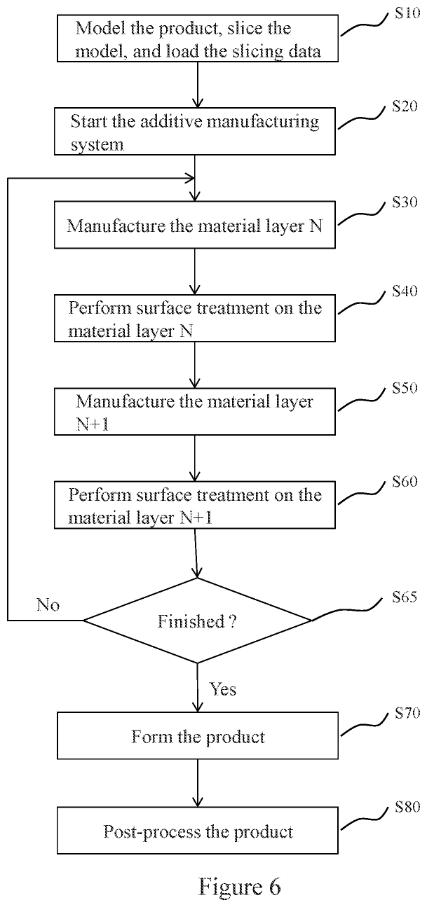

FIG. 6 is a flowchart of an additive manufacturing method according to an embodiment of the present disclosure. As shown in FIG. 6, at step S10, the product to be processed is designed by a computer, which includes modeling the product, slicing the model, and loading the slicing data into the computer or the control unit. Then, in additive manufacturing, the additive manufacturing system is started, referring to step S20. Through additive manufacturing, at step S30, the material layer N is manufactured and formed, and N is an integer greater than or equal to 1. Next, at step S40, surface treatment (for example, polishing treatment or laser treatment) is performed on the formed material layer N to eliminate interlayer defects or layer processing errors. Then, the next material layer is manufactured and formed on the material layer N. Referring to step S50, the material layer N+1 is manufactured. Next, at step S60, surface treatment is performed on the formed material layer N+1 to eliminate interlayer defects or layer processing errors, for example. Then, if it is determined in step S65 that the final product has not been formed, the process returns to step S30 to continue processing the material layer, that is, repeat the above steps. If it is determined in step S65 that the additive manufacturing and surface treatment processes have been completed, and then proceed to step S70, that is, the product is formed. After the product is formed, the product may further be post-processed as needed, referring to step S80. The post-processing includes, for example, heat treatment, machining, cleaning, and the like.

It is noted that the additive manufacturing method according to the present disclosure is not limited to the example shown in FIG. 6. For example, the post-processing in step S80 can be omitted, especially when the product has satisfied the size or performance requirements.

The control unit in the present disclosure may include a processor implement as a computer. The additive manufacturing method described herein may be carried out by one or more computer programs executed by a computer processor. The computer program includes processor-executable instructions stored in a non-transient tangible computer-readable medium. The computer program may further include stored data. Non-limiting examples of the non-transient tangible computer-readable medium are non-volatile memories, magnetic storage devices, and optical storage devices.

The term “computer-readable medium” does not include transient electrical or electromagnetic signals propagating through the medium (for example, on a carrier wave). Therefore, the term “computer-readable medium” shall be regarded as tangible and non-transient. Non-limiting examples of non-transient tangible computer-readable medium are non-volatile memories (such as flash memories, erasable programmable read-only memories, or mask read-only memories), volatile memories (such as static random-access memories or dynamic random-access memories), magnetic storage mediums (such as analog tapes, digital tapes, or hard drives), and optical storage mediums (such as CD, DVD or Blu-ray Disc).

Although the present disclosure has been described with reference to exemplary embodiments, it is noted that the present disclosure is not limited to the specific embodiments or examples described and illustrated in detail herein, and various changes may be made to the exemplary embodiments by those skilled in the art without departing from the scope defined by the appended claims.

1. An additive manufacturing system, comprising:
an additive manufacturing unit comprising a material feeding device and a heat source device, wherein the material feeding device is configured to supply a material onto a substrate for layer-by-layer additive manufacturing, and the heat source device is configured to provide a heat source for fusing the material layer by layer to form material layers;
a surface treatment unit configured to perform surface treatment on the material layers; and
a control unit configured to control the additive manufacturing unit and the surface treatment unit,
wherein the surface treatment unit is configured to perform surface treatment on a material layer N after the material layer N is formed and before a material layer N+1 is formed on the material layer N, where N is an integer greater than or equal to 1.

2. The additive manufacturing system according to claim 1, wherein the surface treatment unit is configured to, once each of the material layers is formed, perform surface treatment on the material layer.

3. The additive manufacturing system according to claim 1, wherein the surface treatment unit comprises a polishing device.

4. The additive manufacturing system according to claim 3, wherein the polishing device is a laser polishing device.

5. The additive manufacturing system according to claim 1, wherein the heat source device is a laser heat source device or an arc heat source device.

6. The additive manufacturing system according to claim 1, wherein the heat source device is a non-molten inert gas shielded welding machine, and/or
in a forming direction of the material layer, the non-molten inert gas shielded welding machine is located behind a molten pool, and the material feeding device is located in front of or behind the molten pool.

7. The additive manufacturing system according to claim 1, wherein the heat source device is a melt inert gas welding machine, and/or
in a forming direction of the material layers, the melt inert gas welding machine is located behind a molten pool.

8. The additive manufacturing system according to claim 1, wherein the heat source device and the surface treatment unit are movable relative to the substrate.

9. An additive manufacturing method, comprising:
supplying a material onto a substrate by a material feeding device for layer-by-layer additive manufacturing; and
fusing the material layer by layer by a heat source device to form material layers; wherein
the method further comprises: performing surface treatment by a surface treatment unit on a material layer N after the material layer N is formed; and forming a material layer N+1 on the material layer N, where N is an integer greater than or equal to 1.

10. The additive manufacturing method according to claim 9, wherein the surface treatment unit performs surface treatment on the material layer after each of the material layers is formed.

11. The additive manufacturing method according to claim 9, wherein the surface treatment unit is configured to perform laser polishing on the material layers.

12. The additive manufacturing method according to claim 9, further comprising: moving the heat source device and the surface treatment unit relative to the substrate during the additive manufacturing and the surface treatment.

13. A computer-readable medium storing a program executed by a processor of a control unit to implement the additive manufacturing method according to claim 9.
